(19) United States
(12) Patent Application Publication
(10) Pub. No.: US 2022/0145702 A1
(43) Pub. Date: May 12, 2022

(54) LADDER TOOL HOLDER DEVICE

(71) Applicant: Spartner Group, Inc., Chicago, IL (US)

(72) Inventor: Chad William Gericke, Chicago, IL (US)

(21) Appl. No.: 17/523,606

(22) Filed: Nov. 10, 2021

Related U.S. Application Data
(60) Provisional application No. 63/112,022, filed on Nov. 10, 2020.

(51) Int. Cl. E06C 7/14

(52) U.S. Cl. CPC E06C 7/14

(57) ABSTRACT

A tool holding device for holding a tool includes a support structure comprising a first side wall, a second side wall, and a top wall. The top wall spans the first side wall and the second side wall, the first side wall comprises a first pair of openings, and the second side wall comprises a second pair of openings. A strap is positioned to extend through the first and second pairs of openings on the first and second side walls, respectively.

### CROSS-REFERENCE TO RELATED APPLICATIONS

This application incorporates by reference and claims the benefit of priority to U.S. Provisional Application 63/112,022 filed on Nov. 10, 2020.

### BACKGROUND

The present disclosure generally relates to devices for holding tools. More specifically, the present disclosure pertains to a tool holder on a ladder.

When undertaking projects on buildings, house maintenance, construction work, etc., workers often need easy access to items such as hand tools, appliances, and fasteners. When these tools are readily accessible to the worker, the project is completed more smoothly and quickly. Workers often utilize a tool holder, such as a tool belt or tool box, to hold the tools they need for the project.

Easy access to tools is important when working on a ladder in order to conveniently finish a project without needing to descend the ladder repeatedly. Some ladders on the market have a support surface on the top of the ladder on which tools may be placed. However, the support surface is very limited in space, and very few tools can be placed on the support surface.

Some ladders include or allow for a tool holder extension to be attached to the support surface of the ladder. A conventional tool holder extension 50 that is removably attached to a support surface of the ladder is shown in FIG. 1. A tool holder extension 52 that is an integral, foldable part of the support surface is shown in FIG. 2. These tool holder extensions provide additional support surfaces and/or compartments for tools.

However, these tool holders are bulky. If the work space is limited, the users would not be able to use these tool holders in the limited work space. Also, these tool holders need to be securely attached to the support surface of the ladder. If the attachment is not secure enough, the tool holder may fall off the ladder, which not only makes it difficult for the user to complete the work, but also is dangerous for anyone who is near the ladder. Moreover, because these tool holders extend from the support surface of the ladder, it may be difficult to maintain the balance of the ladder due to the weight of the tools in these tool holders supported on the top of the ladder. This may cause the ladder to lose balance and thus fall, which would place the user and anyone near the ladder in great danger. Furthermore, specific molds are required to manufacture these ladder tool holders, which increase the cost of manufacturing.

Therefore, a need exists for a simplified device for holding tools atop a ladder, as described herein.

### SUMMARY

The present disclosure provides a tool holding device for conveniently holding tools atop a ladder. For example, the present tool holding device includes a support structure positioned at the top of a ladder that is positioned atop two side rails of a ladder.

The support structure includes a first side wall, a second side wall, and a top wall. The top wall connects the first side wall and the second side wall, and may include openings, slots, cavities, partitions, hooks, compartments, or other features or components in which tools or tool accessories are placed. In one embodiment, the top wall of the support structure includes at least one opening and a recessed compartment. First and second end walls of the support structure may be secured to the two side rails of the ladder on which the tool holding device is mounted.

In one example, the first and second side walls of the support structure include first and second pairs of openings aligned with one another for receiving a strap threaded therethrough. The strap is moveable relative to the side walls of the support structure in order to form loops outside and adjacent to the side walls. The strap provides an additional holding surface for tools that may otherwise not fit on top of the ladder surface, and provide the additional holding space without impacting the overall shape and size of the ladder.

More specifically, first and second portions of the strap extend between each pair of openings to form first and second loops, respectively. Tools such as a hammer or a drill may be placed within and hang from the loops so that the tools are easily accessible.

In some embodiments, the strap has a closed loop configuration, while in other embodiments, the strap includes first and second ends that attach to the first and/or second side walls of the support structure. The strap may be movable through all the openings. The strap also may be made of a non-elastic material such as nylon.

In one embodiment, the first pair of openings on the first side wall may be slots that are substantially parallel to each other. The second pair of openings on the second side wall may be slots that are substantially parallel to each other.

In one embodiment, the second side wall may optionally include a third pair of openings such as but not limited to slots, wherein a third portion of the strap between the third pair of openings on the second side wall can rest against the second side wall and/or be movable away from the second side wall in order to form additional loops for holding tools.

In another embodiment, the first portion of the strap between the first pair of openings on the first side wall may be spaced from the first side wall in a first configuration to form a first loop adjacent to the first side wall for receiving the tool. A second portion of the strap between the second pair of openings on the second side wall may rest against the second side wall in a second configuration.

According to another non-limiting aspect of the present disclosure, a ladder tool holder for holding a tool is provided. The ladder tool holder may comprise a ladder support surface comprising a support structure comprising a first side wall, a second side wall, and a top wall, wherein the top wall connects the first side wall and the second side wall, the first side wall comprises a first pair of openings, and the second side wall comprises a second pair of openings; and a strap passing through the first and second pairs of openings on the first and second side walls.

Additional features and advantages are described herein, and will be apparent from the following Detailed Description and the figures.

### BRIEF DESCRIPTION OF THE DRAWING

Features and advantages of the ladder tool holder described herein may be better understood by reference to the accompanying drawings in which:

FIG. 1 is a perspective view of an exemplary prior art ladder tool holder attachment.

FIG. 2 is a perspective view of a further exemplary prior art ladder tool holder attachment.

FIG. 3 is a perspective front view of an embodiment of the ladder tool holder according to the present disclosure.

FIG. 4 is a perspective back view of the ladder tool holder of FIG. 3.

FIG. 5 is a perspective front view of the ladder tool holder of FIG. 3 during use.

FIG. 6 is a perspective back view of the ladder tool holder of FIG. 3 during use.

FIG. 7 is a perspective back view of an alternative embodiment of the ladder tool holder of FIG. 3.

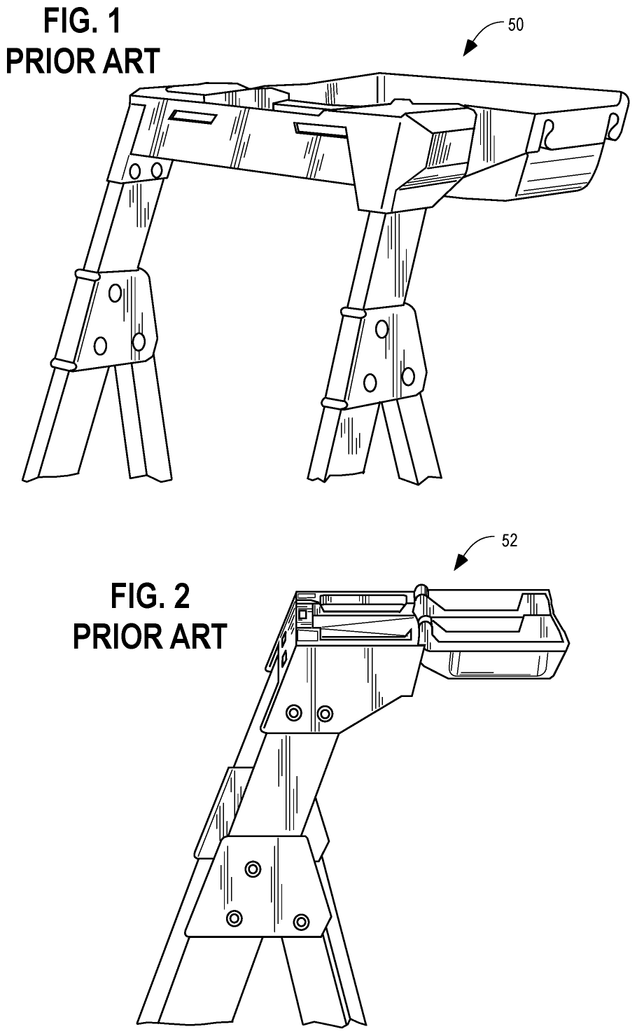

The reader will appreciate the foregoing details, as well as others, upon considering the following detailed description of certain non-limiting embodiments of the ladder tool holder according to the present disclosure. The reader may also comprehend certain of such additional details upon using the ladder tool holder described herein.

### DETAILED DESCRIPTION

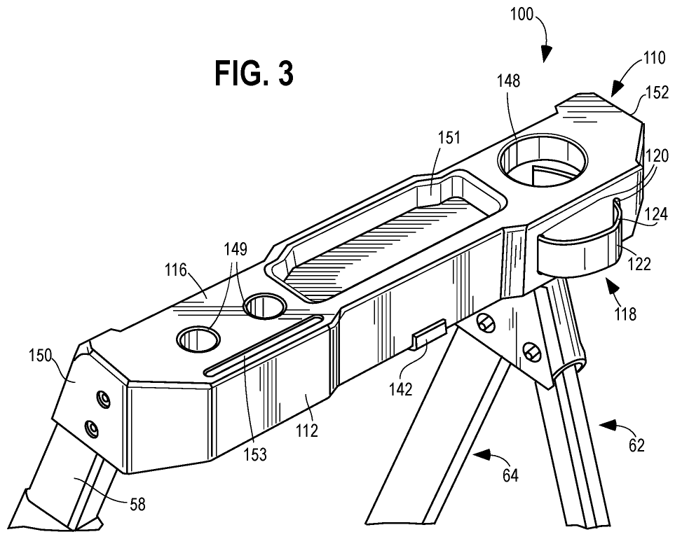

Referring to FIGS. 3-7, the tool holding device 100 of the present application expands the number of tools that a user may position on a top surface of a ladder without impacting the overall shape and size of the ladder. The disclosed tool holder devices 100 are easy and convenient to use, versatile, safe, and secure. Ladders featuring the tool holders of the present application can be used in very limited work space and do not require extended surface and/or space on the top of the ladders.

In a general aspect of the present disclosure, a device 100 for holding tools may comprise a support structure 110 including a first side wall 112 and a second side wall 114 connected by a top wall 116. A strap 118 extends through the side walls 112, 114 of the support structure 110 as shown in FIG. 3. The top wall 116 may include openings, slots, cavities, partitions, hooks, compartments, or other features or components in which tools or tool accessories are placed.

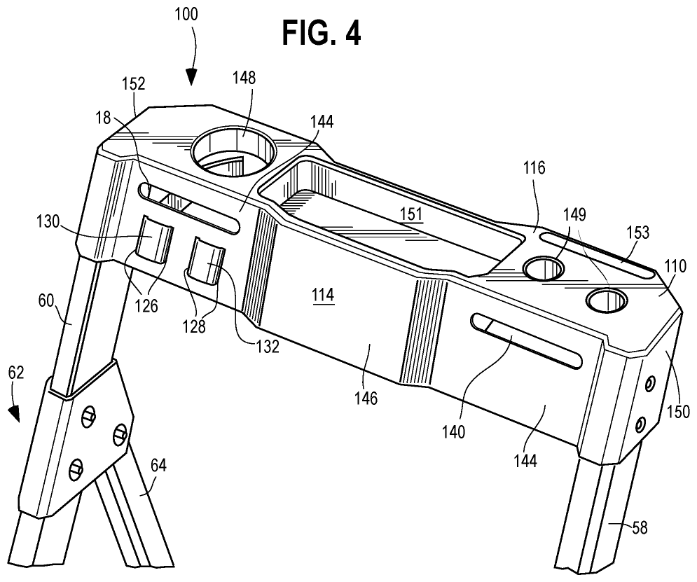

Referring to FIG. 3, the first side wall 112 includes a first pair of openings 120 through which the strap 118 is threaded. The strap 118 is positioned such that a first portion 122 thereof spans the first pair of openings 120 on the first side wall 112 and can be spaced from the first side wall 112 in a first configuration to form a loop 124 to receive a tool, as shown in FIG. 4. In the illustrated embodiment, each opening 120 has a slot shape, although other shapes may be used as desired.

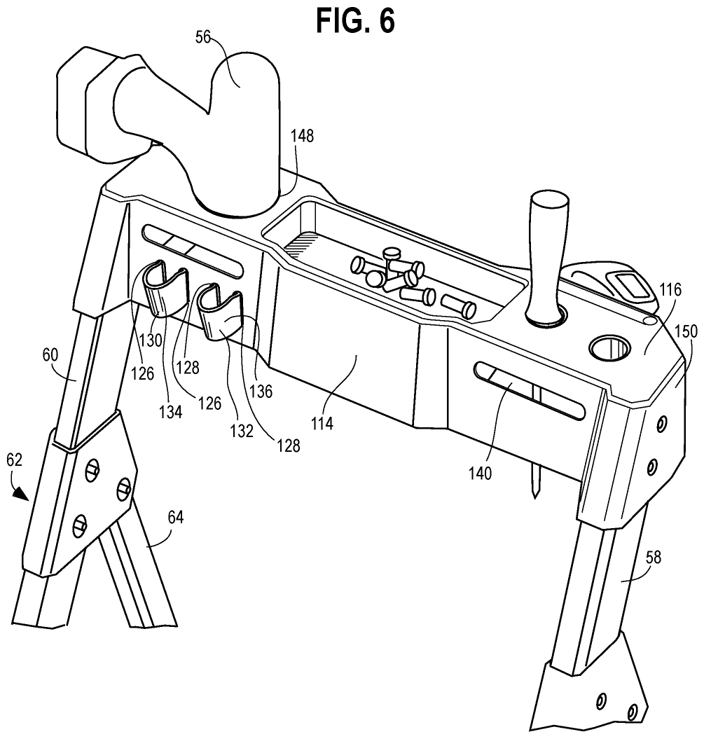

Referring to FIG. 4, the second side wall 114 includes a second pair of openings 126. In the illustrated embodiment, the second side wall 114 also includes a third pair of openings 128, and the strap 118 is positioned such that each of second and third portions 130, 132 spans the first and second pairs of openings 126, 128 and rest against the side wall 114. The strap 118 is moveable so that it can be shifted to create first and second loops 134, 136 adjacent to the side wall 114, as shown in FIG. 6. In the illustrated embodiment, each of the openings 126, 128 has a slot shape, although other shapes may be used as desired.

The strap 118 may have a closed loop configuration and pass through all the openings 120, 126, 128 on the first and second side walls 112, 114. In other embodiments, the strap 118 may have first and second end surfaces that engage with and/or are secured to the openings 120, 126, 128 to hold the end surfaces of the strap 118 to the respective side wall 112, 114 the support structure 110.

The strap 118 is moveable through the openings 120, 126, 128 such that the sizes of the loops 124, 134, 136 can be adjusted. The user may pull any of the first, second, or other portions 122, 130, 132 of the strap 118 to adjust the size of the corresponding loop 124, 134, 136, which would in turn modify the sizes of the other loops. For example, the user can pull the first portion 122 of the strap 118 to increase the size of the first loop 124 and reduce the size(s) of or eliminate the second and/or third loop(s) 134, 136. The user may also pull the second portion 130 of the strap 118 to increase the size of the corresponding loop 134 and reduce the size of the first loop 124 and/or the size of the third loop 136. The user can also pull an internal portion of the strap 118 below the top side wall 116 and between the first and second side walls 112, 114 in order to decrease the sizes of the loop 124, 134, 136.

As illustrated in FIG. 6, a tool 54 such as a hammer may be hung through the loop 124 on the first side wall 112. Tools may similarly be placed within the loops 134, 136 (FIG. 6) on the second side wall 114.

The adjustability of the strap 118 also enables the user to secure the tools in place by tightening the strap 118 within the openings 120, 126, 128. The user can place the hand tool 15 through one of the loops 122, 134, 136, and then pull any other portion of the strap 118 to reduce the size of this loop 122, 134, 136 to secure the tool 15 in place.

In some embodiments, the openings 120, 126, 128 are slots that are sufficiently narrow that the strap 118 is retained in place through a friction fit, requiring a suitable force to move the strap 118 within the openings 120, 126, 128. In other embodiments, the device 100 may include one or more locking mechanisms that hold the strap 118 in place relative to the openings 120, 126, 128. The locking mechanism may, for example, be spring-loaded clips positioned on the inner surfaces of the first and second side walls 112, 114.

In some embodiments, the strap 118 may be made of a non-elastic material. In one embodiment, the strap is made of nylon.

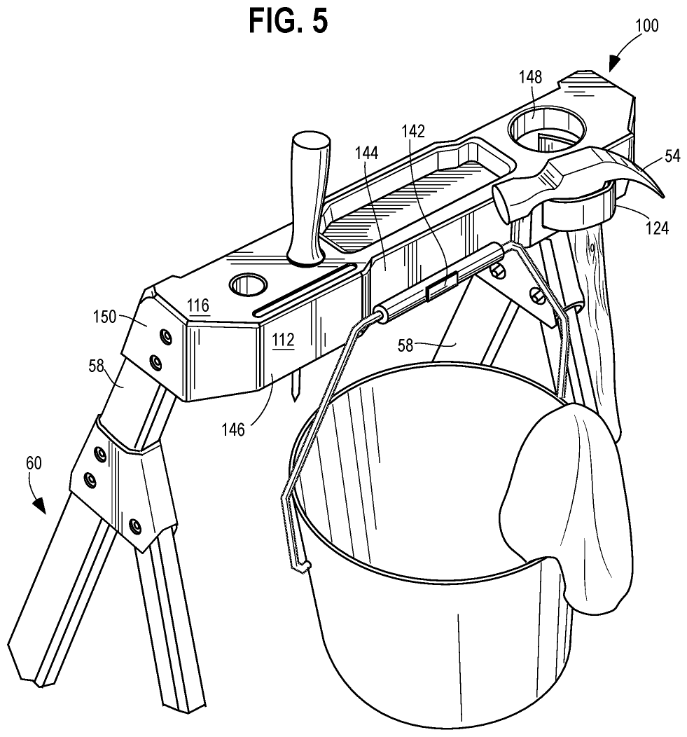

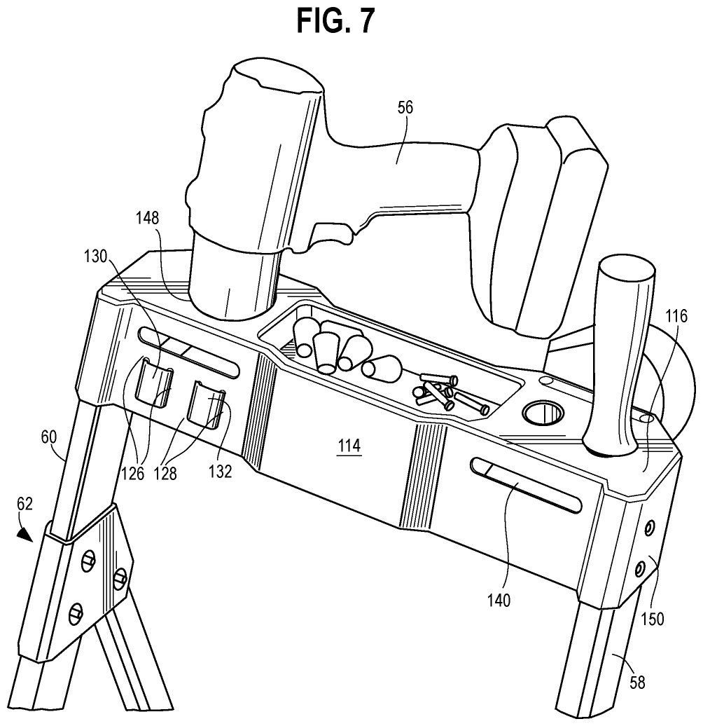

The first and second side walls 112, 114 may also include optional cavities, openings, hooks, or other components or elements for holding tools, pockets, paint cans, straps of tools, etc. As shown in FIGS. 6 and 7, the second side wall 114 may include an optional cavity such as a horizontal opening 140 to provide additional surfaces for holding objects or tools. The further embodiment illustrated in FIG. 7 includes only the second and third pairs of openings 126, 128 on the second side surface 114. In the illustrated embodiment, the front side wall 112 includes a hook 142 for holding a paint can as shown in FIG. 5 or other tool or object. In other embodiments, the hook 142 may be provided on the second side wall 114.

Each of the first and second side walls 112, 114 may be contoured to have one or more inset portion(s) 144 and/or one or more protruding portion(s) 146. The contouring of the first and second side walls 112, 114 may provide structural support for tools extending from the strap 118, tools supported by the top wall 5, and/or the rails of the ladder.

As shown in FIGS. 3-7, the top surface 116 may also include an opening 148 for holding and/or supporting a hand tool 56 or other object. Similar to the retaining of the tool 54 within the loop 124, 134, 136, a tool 56 extending through the opening 148 may include a narrow portion that extends through the opening 148 and a wide portion that rests atop the top wall 116 about the opening 148 as shown in FIGS. 6 and 7. Non-limiting example hand tool 56 include a wrench, pliers, a hammer, a screwdriver, a clamp, a drill, and a knife. The top surface 116 illustrated in FIGS. 3-7 also includes other openings 149 as well as a recessed compartment 151 and a slot 153 for holding tools, screws, hooks, etc. Other embodiments of the tool holding device 100 may include additional or fewer openings and/or compartments as desired.

In the illustrated embodiment, the tool holding device 100 is secured to first and second side rails 58, 60 of a ladder 62, step stool, or similar structure. The support structure 110 may include first and second end walls 150, 152 spanning the first and second side walls 112, 114 at opposing ends thereof. The first and second end walls 150, 152 may be secured directly to the first and second side rails 58, 60 of a ladder 62 and/or may be shaped with the contoured surface of the first and second side walls 112, 114 to form cavities within the support structure 110 for receiving upper ends of the first and second front side rails 58, 60 of a ladder 62, respectively. In other embodiments, the support structure 110 may be sized to receive upper ends of the first and second front side rails 58, 60 as well as the first and second rear side rails of a rear side 64 of the ladder 62. In still further embodiments, an inner cavity of the support structure 110 may include walls, partitions, hooks, shelves, openings, or other structures or components for receiving tools, materials, portions of the ladder, or any other items.

In the illustrated embodiments, the support surface 110 is positioned at the top of the ladder 62, although in other embodiments, the support surface 110 may also be positioned at a mid-level position along the height of the ladder 62. The features described above may be integral to a support surface of the ladder or may be an attachment to a support surface of the ladder. The first, second, and top side walls 112, 114, 116 of the support surface 110 on the ladder may include the features described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A tool holding device for holding a tool comprising:
a support structure comprising a first side wall, a second side wall, and a top wall, wherein the top wall spans the first side wall and the second side wall, the first side wall comprises a first pair of openings, and the second side wall comprises a second pair of openings; and
a strap is positioned to extend the first and second pairs of openings on the first and second side walls, respectively.

2. The tool holding device of claim 1, wherein the strap is movable through the first and second pairs of openings.

3. The tool holding device of claim 1, wherein a first portion of the strap between the first pair of openings on the first side wall is spaced from the first side wall to form a loop adjacent the first side wall for receiving the tool.

4. The tool holding device of claim 3, wherein a second portion of the strap between the second pair of openings on the second side wall rests against the second side wall.

5. The tool holding device of claim 3, wherein a second portion of the strap between the second pair of openings on the second side wall moves between a first configuration and a second configuration, wherein the second portion is spaced from the second side wall in the first configuration, and wherein the second portion rests against the second side wall in a second configuration.

6. The tool holding device of claim 1, wherein the first pair of openings on the first side wall comprise slots that are substantially parallel to each other.

7. The tool holding device of claim 1, wherein the second pair of openings on the second side wall comprise slots that are substantially parallel to each other.

8. The tool holding device of claim 1, wherein the second side wall includes a third pair of openings, and wherein a third portion of the strap spans the third pair of openings on the second side wall.

9. The tool holding device of claim 1, wherein the strap has a closed loop configuration.

10. The tool holding device of claim 1, wherein the strap is made of a non-elastic material.

11. The tool holding device of claim 10, wherein the strap is made of nylon.

12. A ladder comprising:
a support structure comprising:
a first side wall, a second side wall, and a top wall, wherein the top wall spans the first side wall and the second side wall, wherein the first side wall comprises a first pair of openings, and wherein the second side wall comprises a second pair of openings;
a strap passing through the first and second pairs of openings on the first and second side walls, respectively; and
first and second front side rails forming a front side of the ladder, wherein the first front side rail includes a first upper end, and wherein the second front side rail includes a second upper end;
wherein the support structure receives the first and second upper ends of the first and second front side rails, respectively.

13. The ladder of claim 12, wherein the strap has a closed loop configuration.

14. The ladder of claim 12, wherein a first portion of the strap between the first pair of openings on the first side wall is spaced from the first side wall to form a loop configured to hold the tool.

15. The ladder of claim 14, wherein a second portion of the strap between the second pair of openings on the second side wall is spaced from the second side wall to form a further loop configured to hold the tool.

16. The ladder of claim 12, wherein a second portion of the strap between the second pair of openings on the second side wall rests against the second side wall.

17. The ladder of claim 12, wherein the first pair and the second pair of openings are substantially parallel to each other.

18. The ladder of claim 12, wherein the second side wall comprises a third pair of openings, and the strap extends through the second and third pairs of openings on the second side wall.
